(19) United States
(12) Patent Application Publication
(10) Pub. No.: US 2020/0230695 A1
(43) Pub. Date: Jul. 23, 2020

(54) Powder for Use in An Additive Manufacturing Method

(71) Applicant: Heraeus Additive Manufacturing GmbH, Hanau (DE)

(72) Inventors: Tim Protzmann, Wächtersbach (DE); Martin Kunz, Waldbronn (DE); Alexander Elsen, Hanau (DE)

(21) Appl. No.: 16/483,125

(22) PCT Filed: Jan. 3, 2018
(86) PCT No.: PCT/EP2018/050130

§ 371 Date: Aug. 2, 2019

(30) Foreign Application Priority Data
Feb. 8, 2017 (EP) 17155228.4

(51) Int. Cl. B22F 1/00; B33Y 10/00; B33Y 70/00; B22F 3/105; B23K 26/342; B23K 15/00

(52) U.S. Cl. CPC B22F 1/0014; B33Y 10/00; B23K 15/0086; B22F 3/1055; B23K 26/342; B33Y 70/00

(57) ABSTRACT

The invention relates to a powder for an additive manufacturing method having a d₂-value of 10 μm or more, a d₉₀-value of 200 μm or less and a quotient E_{Law}/d₅₀≤0.8 KJ(KG*μm), wherein E_{Law} indicates the avalanche energy and d₅₀ the average particle diameter. The invention further relates to a method for producing a component by means of additive manufacturing using the claimed powder.

Additive manufacturing processes are about to revolutionise existing production processes. Additive manufacturing processes can be used to directly manufacture components having a complex three-dimensional geometry. Additive manufacturing is a term used to denote a process, in which a component is built up through layer-by-layer deposition of material based on digital 3D construction data.

Powder bed-based processes are one version of additive manufacturing processes. Initially, a thin layer of a powder is applied to a construction platform in said powder bed-based additive manufacturing processes. By means of a sufficiently high supply of energy in the form of energy-rich radiation, for example through laser or electron radiation, the powder is melted or sintered, at least partially, at the sites predetermined by the computer-generated construction data. Then, the selectively irradiated site of the powder layer cools down and is cured. Subsequently, the construction platform is lowered and another application of powder follows. The next powder layer is also melted, at least partially, or heated above the sintering temperature and connects to the layer underneath it at the selectively heated sites. These steps are repeated with so many successive layers until the component in its final shape is attained.

Major progress has been achieved in recent years especially with regard to the number of materials that can be processed by means of additive manufacturing. Accordingly, it is now possible to print not only plastic materials, but also high melting point materials, such as, for example, metals or ceramics.

It is the aim of additive manufacturing processes, in particular, to produce components having complex geometries that comprise comparable or even better material properties than the components that can be obtained with known subtractive processes (e.g. CNC milling). Accordingly, for example the tensile strength of a component is directly related to the porosity. The more compact the material can be printed, the higher is the tensile strength of the finished component. Other relevant properties of the finished component include, for example, high edge sharpness and lowest possible surface roughness.

In order to obtain components featuring the highest possible mechanic stability, it is desirable to have a dense powder bed. To attain this, it is preferred for the bulk density of the powder layer to be at least 50%, in particular at least 60%. On the other hand, it is advantageous for powder bed-based processes to have the dynamic properties of the powder, such as, e.g., the flowability, to be adjusted appropriately such that the powder can be applied by means of a doctor blade.

In practical application, it is evident that it is very difficult to optimise the powder properties for both powder application and for the actual manufacturing step at the same time. Commonly, an improvement of a certain property (e.g. flowability) is attained at the cost of a different property (such as, e.g., density of the finished component). However, it has thus far not been possible to use a measured value to predict whether or not a powder can be processed into dense components of low porosity. Rather, it has been necessary thus far to perform extensive printing experiments with each potentially suitable powder in order to afterwards assess the material properties of the printed components.

It is one object of the present invention to provide powders from which complex components of high relative density (i.e. low porosity) can be manufactured by additive manufacturing. Optionally, the components that can be produced from the powder shall also comprise the highest possible edge sharpness and/or the lowest possible surface roughness.

The objects of the present invention are met through independent claim 1.

It has been evident, surprisingly, that powders are particularly well-suited for additive manufacturing by means of selective melting and/or sintering of successive powder layers, if the powders comprise the following features:

a d₂ value of 10 μm or more, a d₉₀ value of 200 μm or less, and a ratio Q of 0.8 kJ/(kg*μm) or less, whereby Q is the ratio of the avalanche energy E_{Law} divided by the mean particle diameter d₅₀ (Q=E_{Law}/d₅₀).

Specification of the parameters of the powder according to the invention allows a reliable statement to be made concerning the suitability of a powder for use in an additive manufacturing process. Extensive printing tests with subsequent mechanical testing can be omitted, which is an enormous easement.

The powder of the present invention is preferably selected from a material that can be sintered and/or melted. In the scope of the invention, materials that can be sintered and/or melted shall be understood to be materials that do not undergo thermal decomposition in an additive manufacturing process at the conditions used in the process. According to the invention, the powder consists of individual particles. The powders comprise a particle size distribution.

The particles of the powder preferably consist of a material that is solid at room temperature and atmospheric pressure. In a preferred embodiment, the material comprises a melting temperature below the decomposition temperature. Optionally, the material can comprise a glass transition temperature. The melting temperature and/or the glass transition temperature of the material, if any, are preferably above 100° C., in particular above 300° C. The glass transition temperature can be determined, for example, by means of dynamic-mechanical analysis or by dynamic differential scanning calorimetry (DSC).

The powder according to the invention can comprise a multitude of materials. The powder can comprise at least one material that is selected from the group consisting of metals, ceramics, glasses, and glass ceramics. In a preferred embodiment, the powder consists of one of the materials specified above. In a preferred embodiment, the powder can just as well be a mixture of powders of different materials.

Presently, “metals” shall be understood to mean both pure metals as well as metal alloys.

The powder according to the invention can contain, as metal, a pure metal, multiple types of pure metals, a type of metal alloy, multiple types of metal alloys or mixtures thereof.

In the scope of the invention, the term, “pure metal”, shall refer to a chemical element that is present in elemental form and is in the same period of the periodic system of the elements as boron, but to the left of boron, in the same period as silicon, but to the left of silicon, in the same period as germanium, but to the left of germanium, and in the same period as antimony, but to the left of antimony, as well as to all elements having an atomic number of more than 55.

The term “pure metals” does not exclude the metal to comprise impurities. Preferably, the total amount of impurities is no more than 1% by weight, in particular no more than 0.1% by weight, and even more preferably no more than 0.01% by weight, relative to the total amount of pure metal. In a particularly preferred embodiment, the pure metal contains no deliberately added elements.

In a preferred embodiment, the pure metal can be a precious metal. In a particularly preferred embodiment, the precious metal is a platinum metal, gold or silver. The platinum metal can be selected from the group consisting of platinum, iridium, palladium, ruthenium, rhodium, and osmium.

In another preferred embodiment, the pure metal can be a refractory metal. The refractory metal can be selected from elements of group 4 (e.g. titanium, zirconium, and hafnium), group 5 (e.g. vanadium, niobium, and tantalum), and group 6 (e.g. chromium, molybdenum, and tungsten).

In another preferred embodiment, the pure metal can be a non-ferrous metal or iron. The non-ferrous metal can be selected from the group consisting of cadmium, cobalt, copper, nickel, lead, tin, and zinc.

According to an embodiment, the metal can be a metal alloy. According to the invention, metal alloys shall be understood to be metallic mixtures of at least two elements of which at least one is a metal. In this context, “metallic” shall be understood to mean that there is a metallic bond between the participating elements.

In a preferred embodiment, the metal alloy can be a precious metal alloy. In a particularly preferred embodiment, the precious metal alloy contains an element selected from the group consisting of platinum metals, gold, and silver.

Preferred platinum metals in the precious metal alloys can be selected from the group consisting of platinum, iridium, palladium, ruthenium, rhodium, and osmium. In a further preferred embodiment, the precious metal alloy can be an alloy of at least two of said platinum metals (e.g. platinum-iridium or platinum-rhodium alloys).

Preferably, the metal alloy can contain elements that are selected from refractory metals, non-ferrous metals, iron as well as combinations of at least two of said metals.

Particularly preferred metal alloys can also be selected from aluminium alloys, nickel-based alloys, cobalt-based alloys, titanium-aluminium alloys, copper-tin alloys, stainless steel alloys, tool steel alloys, and superalloys for high temperature applications.

In a particularly preferred embodiment, the metal alloy can be an amorphous metal. Amorphous metals shall be understood to be alloys comprising metallic bonding characteristics and, concurrently, an amorphous, i.e. non-crystalline, phase. Amorphous metals can have special properties since they are often very hard, but can also be plastically deformable (ductile) and highly elastic. The amorphous metals can be selected from the group consisting of titanium-, zirconium-, iron-, nickel-, cobalt-, palladium-, platinum-, copper-, gold-, magnesium-, calcium- and aluminium-based alloys. In this context, “based” shall be understood to mean that the respective element represents the largest fraction relative to the weight of the alloy. Particularly preferred examples of alloys forming amorphous metals are selected from the group consisting of NiNbSn, CoFeTaB, CaMgAgCu, CoFeBSiNb, FeGa(Cr,Mo)(P,C,B), TiNiCuSn, FeCoLnB, Co(Al,Ga)(P,B,Si), FeBSiNb, Ni(Nb,Ta)ZrTi. Specifically, the amorphous metal can be a ZrCuAlNb alloy. Preferably, said ZrCuAlNb alloy comprises, in addition to zirconium, 23.5-24.5% by weight copper, 3.5-4.0% by weight aluminium as well as 1.5-2.0% by weight niobium (commercially available by the name of AMZ4® from Heraeus Deutschland GmbH).

On principle, suitable processes for the production of metal powders are known to a person skilled in the art. Preferably, the production of the powder from metal particles takes place by means of an atomisation process, in particular a plasma atomisation, a centrifugal atomisation or a crucible-less atomisation.

In an embodiment, the material of the powder according to the invention can be a ceramic material. In the context of the invention, ceramics shall be understood to be crystalline inorganic materials that have no metallic characteristics. In a preferred embodiment, the ceramic material can comprise natural minerals. The ceramic material can be selected from the group consisting of oxide ceramics, nitride ceramics, carbide ceramics as well as mixed forms of at least two of said ceramics.

The oxide ceramics can preferably comprise oxides of the elements selected from the group consisting of magnesium, calcium, aluminium, silicon, titanium, zirconium, and zinc. The oxide ceramic material can comprise pure element oxides or mixed oxides. In a preferred embodiment, the element oxides are selected from the group consisting of magnesium oxide, calcium oxide, aluminium oxide, silicon oxide, titanium oxide, zirconium oxide, and zinc oxide. In another preferred embodiment, the mixed oxides contain at least two of the elements selected from the group consisting of magnesium, calcium, aluminium, silicon, titanium, zirconium, and zinc. Optionally, the mixed oxides can contain additional elements that are selected from the group consisting of the elements of main groups 3 through 6 of the periodic system of elements. Ceramic powders of different shape and size can be produced by processes that are known to a person skilled in the art, e.g. by grinding.

In an embodiment, the material of the powder according to the invention can be a glass. In the scope of the invention, a glass shall be understood to be an inorganic amorphous material that comprises no metallic bonding characteristics. The glasses can be oxidic glasses. Oxidic classes can be selected from the group consisting of silicate glasses, borate glasses, phosphate glasses. The name of said preferred oxidic glasses each indicates which component predominates relative to the weight. For example, silicate (SiO₄⁴⁻) is the most common component of silicate glasses. Each of the specified types of glasses can contain additional elements in the form of oxides, whereby said additional elements can be selected, for example, from alkali metals, alkaline earth metals, aluminium, boron, lead, zinc, and titanium.

The glass powders can be produced according to processes that are known to a person skilled in the art, for example by grinding or chemical syntheses (e.g. precipitation, sol-gel process).

In an embodiment, the powder can contain a glass ceramic material. Glass ceramics are inorganic materials that comprise no metallic characteristics and comprise both an amorphous and a crystalline phase.

Preferably, at least 80% of the particles meet the following condition:

0.8≤dₘᵢₙ/dₘₐₓ≤1.0;

whereby dₘᵢₙ is the minimum diameter and dₘₐₓ is the maximum diameter of a particle.

In as far as reference to the parameters, d₂, d₅₀, and d₉₀ is made in the context of powders according to the invention, those parameters can be determined as follows. The measurement can be done on the corresponding powder as a dry dispersion by means of laser diffraction particle size analysis according to ISO 13320:2009 and the cumulative volume distribution curve can be determined from the measured data. According to ISO 9276-2:2014, the values of d₂, d₅₀, and d₉₀ can be calculated from the volume distribution curve. In this context, for example, “d₂” means that 2% by volume of the particles have a diameter of less than this value.

The powder according to the invention has a d₂ value of 10 μm or more, in particular 20 μm or more, and particularly preferably 30 μm or more. Moreover, the powder according to the invention has a d₉₀ value of 200 μm or less, preferably 150 μm or less, in particular 100 μm or less, and particularly preferably 65 μm or less. Typical powders comprise particle size distributions, for example, in the range of 10-32 μm, 10-45 μm, 20-63 μm, 45-100 μm, 45-150 μm. In this context, the value ahead of the hyphen each refers to the d₂ value and the value after the hyphen refers to the d₉₀ value.

Moreover, the powder according to the invention comprises a ratio Q of 0.8 kJ/(kg*μm) or less, whereby Q is the ratio of the avalanche energy E_{Law} and the mean particle diameter d₅₀ (Q=E_{Law}/d₅₀) In a preferred embodiment, the ratio Q takes on a value of 0.65 kJ*μm/kg or less, in particular a value of 0.5 kJ*μm/kg or less. In the scope of the present invention, the avalanche energy E_{Law} can be determined by revolution powder analysis. The procedure of revolution powder analysis is described in the section, “Measuring methods”.

The powder of the present invention can be found with a process that is characterised by the following sequence of steps:
a) Providing a powder made of a material that can be melted and/or sintered;
b) sizing the powder such that the particle size distribution meets the conditions, d₂≥10 μm and d₉₀≤200 μm;
c) determining the flowability by means of revolution powder analysis and determining the d₅₀ value by means of laser diffraction analysis according to ISO 13320:2009;
d) calculating the E_{Law}/d₅₀ ratio;
e) selecting powders with an E_{Law}/d₅₀ ratio of no more than 0.80 kJ/(kg*μm).

Through the use of the process specified above, it is possible to identify powders that can be used in an additive manufacturing process, in particular in a powder bed-based process, such as, e.g., selective laser melting.

In step b), the powder is subjected to at least one sizing process. Screening and sifting are preferred sizing processes. Screening can take place, e.g. by means of a tumble screen, rotating screen or vibrating screen. Usually, common screening mesh made of stainless steel is used for screening. Sifting processes for powders are generally known to a person skilled in the art. The sifting can take place, e.g., by wind sifting.

Just as well, two or more of said sizing processes can be performed consecutively in order to attain a particle size distribution that is adjusted as accurately as possible. For example, initially one or more screening processes and subsequently one or more sifting processes can be performed. In this context, the powders can be largely freed of particles that comprise a particle size diameter of less than 10 μm (i.e. d₂≥10 μm) and more than 200 μm (i.e. d₉₀≤200 μm).

Following the sifting, the avalanche energy (E_{Law}) can be determined by revolution powder analysis and the d₅₀ value can be determined by laser diffraction analysis. The measuring methods used for this purpose are described below.

Using the values thus determined, the ratio Q of the avalanche energy (E_{Law}) and the mean particle diameter d₅₀ can be determined (Q=E_{Law}/d₅₀).

Then, in step e), the powders that comprise a ratio Q of no more than 0.80 kJ/(kg*μm) can be selected. In a preferred embodiment, Q is 0.65 kJ*μm/kg or less, in particular 0.5 kJ*μm/kg or less. If the powder fails to meet the required value, it can either be processed further in order to meet the E_{Law}/d₅₀ value or the powder can be discarded and/or recycled.

The ratio Q is a measure of the flowability of a powder. A person skilled in the art is basically aware of how to further influence the flowability of a powder after the production process. The flowability of a powder can be influenced, for example, during the production of the powder, by after-treatment or through a combination of both. Spherical particles favour better flowability during the production process. The flowability can be varied for example by adjusting the moisture content of the powder. It is also feasible to modify the flowability after the production of the powder by modifying the particle surface, for example through temperature treatment or grinding. In one possible embodiment, the measures specified above can be used to vary the flowability of those powders that do not meet the conditions for Q.

Moreover, the present invention relates to a process for the production of a component by means of additive manufacturing, comprising the steps of:
a) Providing a powder comprising a d₂ value of 10 μm or more, a d₉₀ value of 200 μm or less, and an E_{Law}/d₅₀ ratio of no more than 0.80 kJ/(kg*μm), and
b) additive manufacturing of the component using the powder from step a).

The powder provided in step a) is used for additive manufacturing of a component in step b). In the scope of the present invention, additive manufacturing processes shall be understood to be those, in which at least one powder layer is heated selectively to the sintering and/or melting temperature. Said additive manufacturing processes are also called powder bed-based processes. The heated layer can be converted into a solidified layer, e.g. by cooling. In a preferred embodiment, at least two solidified layers are generated one over the other, each from a powder bed (i.e. a powder layer). Said additive manufacturing processes are known, on principle, to a person skilled in the art.

Selective laser sintering (SLS), selective laser melting (SLM), and selective electron beam melting (EBM) shall be mentioned presently for exemplary purposes. In a preferred embodiment, it is possible to combine the additive manufacturing process with machining processes.

The preferred procedure of the additive manufacturing according to step b) of the process according to the invention can comprise the following sub-steps of:
b1) Applying a layer of the powder according to the invention, e.g., to a building panel;
b2) heating at least part of the powder of the first layer to the sintering and/or melting temperature by means of laser or electron radiation and subsequently cooling the heated powder.

Optionally, the process further comprises the steps of:
b3) Applying another layer of a powder according to the invention onto the layer generated previously;
b4) heating at least part of the powder of the further layer to the sintering and/or melting temperature by means of laser or electron radiation and subsequently cooling the heated powder.

In analogy to steps b3) and b4), any number of further layers can be applied onto each other subsequent to b4) until the finished component is obtained.

Optionally, further steps can take place each between steps b1)-b4) as long as the sequence of steps is maintained.

In step b1), a first layer of the powder according to the invention is applied onto a building panel. Preferably, the building panel is level and comprises a high thermal conductivity. Preferably, the building panel is made of metal. The powder layer can preferably be applied with a doctor blade. The application of the first layer is preferred to take place in a closed assembly space. Optionally, the assembly space is evacuated or filled with an inert gas (e.g. nitrogen or a noble gas) before step b1).

In step b2), at least part of the powder of the first layer is heated by laser or electron radiation to the sintering and/or melting temperature. The heating takes place appropriately such that the sintering temperature and/or the melting temperature of the particles of the powder is exceeded. The sintering temperature shall be understood to be the temperature from which diffusion of atoms of a particle to the contact site of a neighbouring particle is made feasible, e.g. by means of surface diffusion along the particle surface.

The control of the area, in which the energy-rich radiation acts on and heats the layer of the powder, preferably is assumed by a computer control. 3D models of the component to be manufactured, decomposed into a multitude of virtual sections, can be used for this purpose. Each of said virtual sections of the 3D model can then serve as a template for the area of an applied powder layer that is to be heated.

After heating, the heated area is cooled down below the melting and/or sintering temperature. In the process, the previously heated powder layer stiffens and/or solidifies.

In step b3), a further layer of the powder according to the invention is applied onto the previously generated layer.

In step b4), at least part of the powder of the further layer is heated to the sintering or melting temperature of the powder particles, as before. Due to the particles being heated beyond the sintering or melting temperature, the material of a particle can become connected both to the material of a neighbouring particle of the same layer and to the material of a neighbouring particle of the previously generated layer.

Once the manufacturing of the component is completed, non-sintered and/or non-melted, loose powder can be removed. The removal can take place, e.g., by sandblasting or aspiration.

Optionally, the component can be subjected to an after-treatment after the additive process, whereby the after-treatment can be selected from the group consisting of ablative treatments (such as, e.g., grinding, polishing, milling, drilling, etching, laser or plasma ablation), build-up treatments (such as, e.g., coating, painting, sputtering, welding, soldering), thermal treatments (e.g. heating and cooling), electrical treatments (electro-welding, electro-plating, eroding), pressure change (pressure increase, pressure decrease), mechanical deformation (pressing, rolling, stretching, forming), and any combinations of at least two thereof.

Due to the use of the powder according to the invention in an additive manufacturing process, components of high relative density (i.e. very low porosity) can be manufactured. A high relative density is important, specifically, in order to obtain mechanically stable components, since holes or voids can be potential sites of fracture. Moreover, thermally-insulating gas inclusions can also impair the thermal conductivity. Said insulating areas in the material can be disadvantageous, in particular, if the component is required to have a high thermal conductivity.

Moreover, the process according to the invention allows a component to be obtained that has a relative density of more than 90%, preferably of more than 95%.

The manufactured component can, for example, be cooling elements, topology-optimised lightweight components, medical devices or personalised implants.

The use of the powder according to the invention allows components with complex or delicate structures to be manufactured. The process according to the invention is well-suited, in particular, for the manufacture of components that cannot be manufactured through conventional subtractive processes, such as, e.g., milling, due to their complex geometry.

Measuring Methods

In as far as standards are specified in the copy, these references always refer to the version that was Valid at the Application Date.

Particle Size Distribution

The particle size distribution can be determined by laser diffraction according to ISO 13320:2009 using the “Helos BR/R3” device (Sympatec GmbH, Germany). Depending on the particle sizes present in the powder, the measuring range here is either 0.9-875 μm.

The dry dispersing system, RODODS/M (Sympatec GmbH, Germany) with vibratory feeding unit VIBRI (with Venturi nozzle), can be used for dispersing the powder particles. The sample amount in this context is 5 g. The wavelength of the laser radiation used in the process is 632.8 nm. The analysis can be done based on the Mie theory. The particle size is obtained in the form of a volume distribution, i.e. the particle size distribution is determined in the form of a volume distribution summation curve in the scope of the present invention.

The d₂, d₅₀ and d₉₀ values can be calculated from the particle size distribution measured by laser diffraction (volume distribution) as described in ISO 9276-2:2014.

### Avalanche Energy

To determine the avalanche energy (E_{Law}) of the powders according to the invention, the powders can be characterised by means of the revolution powder analysis described herein. For example a Revolution Powder Analyzer Model Rev2015 (from Mercury Scientific Inc., Newton, USA) running the Revolution Version 6.06 software can be used to determine the avalanche energy. In the scope of the present invention, the following procedure is used to measure the avalanche energy:

The bulk weight and the bulk volume are used to determine the bulk density of the powder. A cylindrical measuring drum is filled with 100 ml of powder. The measuring drum has a diameter of 100 mm and a depth of 35 mm. The measuring drum rotates about the horizontally-oriented cylinder axis at a constant speed of 0.3 revolutions per minute. One of the two front faces of the cylinder, which together enclose the powder filled into the cylindrical measuring drum, is transparent. Before the measurement is started, the measuring drum is rotated for 60 seconds. For the actual measurement, a camera is used to take pictures of the powder during the revolution along the rotary axis of the measuring drum at an image rate of 10 images per second. In this context, the camera parameters are selected appropriately such that the highest possible contrast is attained at the powder-air interface. During the rotation of the measuring drum, the powder is dragged along against gravity up to a certain height, before it flows back into the lower part of the drum. The flowing back usually occurs in a jerky motion (discontinuous) and is also called an avalanche. A measurement is completed, when the slippage of 150 avalanches has been recorded.

Subsequently, the images of the measured powder are analysed by means of digital image analysis. The image is subdivided into pixels of equal size. The area and the number of the pixels depend on the camera that is used. Dark pixels are allocated to the powder and light pixels are allocated to the air volume above the powder. For each pixel allocated to the powder the corresponding volume (pixel area*drum depth) and the density of the powder are used to calculate the mass of the pixel.

Moreover, the distance h to the baseline is determined for each pixel in each image. The baseline is situated outside of the measured powder as a horizontal tangent below the circumference of the measuring drum.

This data can be used in the equation Eₚₒₜpixel=m*g*h to calculate the potential energy of each pixel (m=mass [kg], g=gravitational acceleration [m*s⁻²], h=height above baseline [m]). The sum of all calculated Eₚₒₜpixel per image is used to calculate the potential energy of the entire powder at the time of the recording (EₚₒₜPulv). The specific potential energy of the powder EₚₒₜₛPulv is calculated by dividing the EₚₒₜPulv thus obtained by the mass of the powder used. The specific potential energy of the powder at the time of each image is recorded. When the powder is dragged along during the revolution of the drum, the potential energy increases to a maximum value and then decreases to a minimum value after slippage of an avalanche. Due to said periodic slippage of the avalanches, the EₚₒₜₛPulv varies within certain limits during the measurement.

The difference between each EₚₒₜₛPulv peak and the subsequent EₚₒₜₛPulv trough is calculated, by means of which the potential energy of each individual avalanche E_{Low_single}, is determined. The mean of the avalanche energy E_{Low} is calculated from all individually determined values of the avalanche energy E_{Law_single}.

Porosity

The porosity is described by the following equation:

Porosity P (in %)=(1−(ρ_{geo}/ρₜₕ))×100%,

whereby
ρ_{geo} is the geometric density of the component and ρₜₕ is the theoretical density of the component.

The geometric density can be determined according to the principle of Archimedes, for example using a hydrostatic scale. The theoretical density of the component corresponds to the theoretical density of the material from which the component is made. The relative density Dᵣₑₗ (in %) follows from (ρ_{geo}/ρₜₕ)×100%.

### EXEMPLARY EMBODIMENTS

Powders made from various materials that can be melted and/or sintered were sized by screening (Table 1). An AS 200 unit from Retsch GmbH, Germany, was used for screening Stainless steel screens with a mesh width of 10 μm, 20 μm, 45 μm, 63 μm, and 140 μm were used and approximately 100 g of powder were strained at different amplitudes for 2-5 minutes.

The d₂ and d₉₀ values of the sized powders were determined. If the values did not meet the conditions, i.e. d₂ value ≥10 μm and d₉₀ value ≤200 μm, after the screening, further sizing steps were undertaken until the particle size distribution was within the specified limits. A person skilled in the art knows how to appropriately select the mesh width of the various screens in order to remove particles from the powder which are outside the defined range.

If the powders met the specified conditions, i.e. d₂ value ≥10 μm and d₉₀ value ≤200 μm, the d₅₀ value and the avalanche energy of the powders were measured as well and the (E_{Law}/d₅₀) ratio was calculated.

All powders subjected to the measurements were used to produce a cube with an edge length of 10 mm by means of “selective laser melting” (SLM) using a facility of ConceptLaser GmbH, Germany, model MLab. The same process parameters were used throughout (laser power: 95 W, laser speed: 150 mm/s, line distance: 0.09 mm).

The geometric density and the relative density of the components obtained were determined as described above.

The results for the powders and the component manufactured from them are summarised in Table 1.

TABLE 1
Summary of the characterised powders and bodies made
from them. Quality of printed part: good =
relative density >95%, poor ????

| | | | | Relative |
|---|---|---|---|---|
| Material | Experiment | d₅₀ | E_{Law}/d₅₀ | density |
| CuSn8 | 1 | 31 | 0.29 | good |
| | 2 | 46.53 | 0.13 | good |
| | 3 | 33.94 | 0.27 | good |
| | 4 | 46.9 | 0.19 | good |
| | 5 | 66.87 | 0.07 | good |
| | 6 | 75.75 | 0.07 | good |
| | 7 | 24.03 | 0.48 | good |
| CuSn10 | 8 | 27.18 | 1.23 | poor |
| | 9 | 25.3 | 0.56 | good |
| Ti6Al4V | 10 | 91.81 | 0.27 | good |
| | 11 | 33.93 | 1.49 | poor |
| | 12 | 39 | 0.33 | good |
| AlSi10Mg | 13 | 25.11 | 0.72 | good |
| | 14 | 23.85 | 2.55 | poor |
| AMZ4 | 15 | 87 | 0.31 | good |
| (ZrCuAlNb) | 16 | 46 | 1.10 | poor |
| Al₂O₃ | 19 | 79 | 0.10 | good |
| ceramics | 20 | 4 | 2.40 | poor |

It is evident from Table 1 that the mean particle diameter d₅₀ alone is not a suitable selection criterion for suitable particles. This is evident, in particular, by comparison of the particle sizes of experiments 3, 8, and 13 in Table 1, which allow no trend in terms of the quality of the finished component to be recognised.

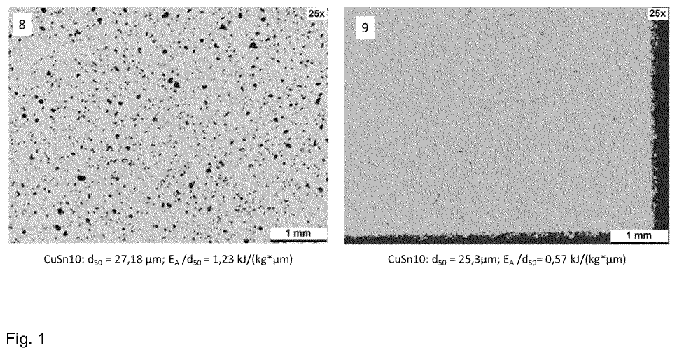

FIG. 1 shows, in an exemplary manner, light microscopy images of the printed components made from powders 8 and 9. As is evident, powder 9 comprises a clearly lower porosity than powder 8.

1. A powder for an additive manufacturing process, comprising:
a) a d₂ value of 10 μm or more;
b) a d₉₀ value of 200 μm or less; and
c) a E_{Law}/d₅₀ ratio of ≤0.8 kJ/(kg*μm), whereby E_{Law} is the avalanche energy and d₅₀ is the mean particle diameter.

2. The powder according to claim 1, characterised in that the powder comprises an E_{Law}/d₅₀ value of 0.65 kJ/(kg*μm) or less, in particular of 0.5 kJ/(kg*μm) or less.

3. The powder according to claim 1, characterised in that the material is a metal.

4. The powder according to claim 3, characterised in that the metal is selected from the group consisting of precious metals and base metals.

5. The powder according to claim 1, characterised in that the metal is an alloy.

6. The powder according to claim 1, characterised in that the alloy is selected from the group consisting of titanium-aluminium alloys, copper-tin alloys, aluminium alloys, steel alloys, and nickel-based alloys.

7. The powder according to claim 1, whereby the metal is an amorphous metal.

8. The powder according to claim 7, whereby the amorphous metal is selected from zirconium-based amorphous metals, copper-based amorphous metals, and iron-based amorphous metals.

9. The powder according to claim 1, characterised in that at least 80% of the particles meet the following condition: 0.8≤dₘᵢₙ/dₘₐₓ≤1.0, whereby dₘᵢₙ is the minimum diameter and dₘₐₓ is the maximum diameter of a particle.

10. (canceled)

11. (canceled)

12. A process for the production of a component by means of additive manufacturing, comprising the steps of:
a) Providing a powder comprising a d₂ value of 10 μm or more, a d₉₀ value of 200 μm or less, and an E_{Law}/d₅₀ ratio of no more than 0.80 kJ/(kg*μm), and
b) additive manufacturing of the component from the powder.

13. The process according to claim 12, whereby step a) comprises the following sub-steps:
a1) Providing a powder;
a2) sizing the powder such that the particle size distribution meets the conditions, d₂≥10 μm and d₉₀≤200 μm;
a3) selecting powders with an E_{Law}/d₅₀ ratio of no more than 0.80 kJ/(kg*μm).

14. The process according to claim 12, whereby step b) comprises the following sub-steps:
b1) Applying a layer of the powder;
b2) heating at least part of the powder to the sintering and/or melting temperature by means of laser or electron radiation and subsequently cooling the heated powder.
